(19) United States
(12) Patent Application Publication
(10) Pub. No.: US 2013/0268934 A1
(43) Pub. Date: Oct. 10, 2013

(54) DYNAMIC METHOD FOR CONTROLLING THE INTEGRITY OF THE EXECUTION OF AN EXECUTABLE CODE

(71) Applicant: Benoît Gonzalvo, La Ciotat (FR)

(72) Inventor: Benoît Gonzalvo, La Ciotat (FR)

(73) Assignee: GEMALTO SA, Meudon (FR)

(21) Appl. No.: 13/992,062

(22) PCT Filed: Dec. 9, 2011
(86) PCT No.: PCT/EP2011/072366

§ 371 Date: Jun. 6, 2013

(30) Foreign Application Priority Data
Dec. 17, 2010 (EP) 10306453.1

(51) Int. Cl. G06F 9/54

(52) U.S. Cl. CPC G06F 9/54
USPC 718/1; 718/107

(57) ABSTRACT

The present invention describes a method for securing the execution of a computer program in a multitask device. This method is based on the execution, in parallel with the program to be made secure, of a security thread, able to modify the parameters of the scheduler.

The present invention relates to the field of the faults detection in the execution of a computer program by an electronic component.

Chip cards, and more generally some portable electronic components are often used as a unit for computing and storing secret and/or sensitive data with a view to securing an application. The identity, the cellular telephony, payments, transports or access control are all fields of application wherein the chip cards play an essential part.

This role consists, among others and not restrictively, in authenticating the card holder and/or the card issuer. The card may also contain “units” which may correspond to loyalty points, money (for example telephone units) or subway tickets, depending on the application.

The card is thus, for some malicious people or organizations, a favourite target for frauding or for affecting a company's image.

Since their deployment, cards have to face threats, among which the observation of power consumption (Differential Power Analysis), and also recently attacks by injection of transient faults. The detection of such attacks is relatively complex and the response to such attacks is hard to implement. The current electronic components are not capable to guarantee a correct operation, whatever the external disturbances. The result is that the software or the operation system aboard the card must protect itself from possible failures of the component caused by the injection of errors, to prevent the corruption of sensitive data.

The prior art already knows solutions for detecting disturbances, for instance glitches (voltage pulse) which could entail a fault in the operation of the electronic components. It should be noted that hardware solution exist, which consist in integrating environmental (temperature, clock frequency, voltage, light) sensors which will detect a disturbance (an abnormally low voltage, too high light intensity) in order to react before entering an operation zone of the component which is estimated unstable and thus dangerous, as regards faults. Such solutions are expensive since they require the development of specific sensors (economic cost) and the integration thereof into sometimes small circuits (dimension cost).

Solutions are also known which detect the effect of the disturbance undergone, for instance, through the presence of a modified data bit.

Distinction can be made between, among others, software or hardware solutions of the process redundancy type. Simplistically speaking, redundancy consists in carrying out twice the same operation (computing, transmission, . . . ) in order to compare the results of the two actions. In software mode, redundancy may be a double computing of data. In hardware mode, such redundancy can be revealed by the presence, for instance, of two duplicate registers storing, a priori, the same values. If the results are different, then it may reasonably be concluded that one of the actions failed, probably due to a disturbance (fault).

Software or hardware solutions of the integrity controlling type, also exist. To a data item stored in a non volatile memory is added a “checksum” of the data item, with this sum making it possible to detect whether the data item is corrupted by a fault prior to the checksum verification, in case of inconsistency between the data item and the checksum. Adding integrity data is common in the software layers, for instance for the transmission of data. The hardware checksum, as can be found in the prior art, is only implemented at the level of memory block, and is often called a “parity bit”. The elementary machine word (8 bits on a 8-bit component) is stored on 9 bits in the memory, with the 9^{th} bit being a parity bit so positioned that the parity of the word is systematically even/odd. Upon reading, parity is checked and the 8-bit word is positioned in the data bus. Upon writing, the 8-bit word positioned in the data bus is written into the memory and the parity bit is generated at the same time. The problem lies in that, in the data bus, the transmitted word includes no integrity data: it is impossible to check that this value, once transferred to the memory, the central processing unit CPU or the cache, is still correct.

Such solutions are sufficient for “accidental” faults which occur during the execution of an instruction, for instance in the aerospace field, as faults are punctual (pulses) and affect either the data item (or sensitive process), or its redundancy or the checksum thereof. It should be noted that any decision process or tampering of sensitive data or cryptographic computing can be considered as sensitive. As a non limitative example, can be cited, the decision process of accepting an instruction or of accepting an operation of reading/writing/deleting a file or accepting a debit or a credit on an electronic scale or comparing a secret code or a MAC (Message Authentication Code) can be cited.

However, malicious persons may repeat faults on the electronic components and adapt their techniques until they succeed. It can thus be envisaged that the hacker will try to repeat the same fault both on the sensitive process and on the redundant process so that the fault is not detected.

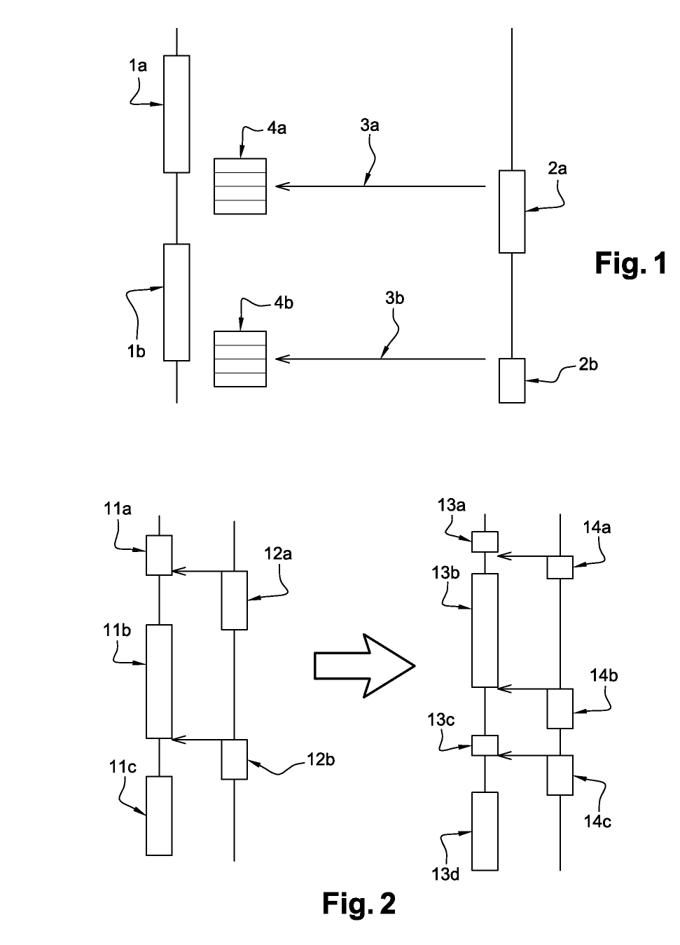

The prior art thus knows a solution consisting in inserting, as shown in FIG. 1, a random delay between a sensitive process and the redundancy thereof. Such solution significantly increases the resistance of the protection against faults.

However all such countermeasures, like any executable computer code, can be observed by a malicious person. As such countermeasures are in essence positioned close to the sensitive operations, the detection thereof can unveil critical information.

New attacks have thus been developed by malicious persons: i.e. fault combination.

This attack category consists of a sequence of at least two consecutive faults, one in the sensitive operations and the other one in the countermeasure supposed to protect them. Then it is possible to disturb the implementation of the sensitive operations, and to prevent the detection of such act by the countermeasures. The countermeasures are generally attacked during the writing operation which consists in writing the detection of the fault into a memory. The hacker thus detects the countermeasure and causes a fault in order to prevent such writing operation.

Generally speaking, the solutions of the prior art do not make it possible to efficiently face consecutive disturbances which can affect both the sensitive processes and the associated countermeasures.

In the field of the creation and democratisation of multitask operating system, the word “Thread” shall be used in the present document to refer to a sequence of computer instructions. A thread can be compared to a process, and generally consists of a portion of a more complex program.

Such systems make it possible to execute several programs in parallel. Most often, such systems use one and only one processor. Multitask operation is then obtained by assigning the processor sequentially to each one of the programs which are executed “in parallel”. Such mechanism, which manages the load of a processor, and assigns it to the various programs to be executed, is commonly called a scheduler.

The present invention intends to remedy the drawbacks of the prior art by providing a method for detecting faults based on a multitask operating system.

The invention is particularly adapted to the protection of execution environments such as virtual machines, for instance in a Java environment and the derivatives thereof.

Therefor, the invention firstly provides a method for securing the execution, in an electronic device including at least one processor and one memory, of a computer program in a multitask environment comprising a program called a scheduler, for managing the load of said processor. Such method at least comprises:
the execution of a security thread, in parallel with the execution of said computer program,
the execution by said thread, of at least a controlling operation on the execution of said computer program,
the analysis of the results of said controlling operation
the sending of at least one item of information to the scheduler.

The computer program can be executed within a virtual machine.

In one embodiment, the controlling operation may consist, for instance, in analyzing in the memory, the values produced by the computer program, or in analyzing at least one sensor, with such sensor being a hardware sensor or a software sensor.

If the computer program is executed with a virtual machine, the controlling operation may, for instance, consist in either analyzing the stack of the virtual machine or in analyzing the heap of the virtual machine, or in analyzing the execution stack of the virtual machine, or in analyzing the execution counter of the virtual machine.

The item of information transmitted to the scheduler may consist of an activation frequency of said security thread.

Secondly the invention provides a computer program for managing the load of a processor in a multitask environment, having means so configured as to:
execute a security thread in parallel with the execution of a program to be made secure,
receive an item of information from said thread,
depending on said received item of information, modify the activation frequency of each one of the processes being executed by the processor.

The modification in the activation frequency of each process being executed by the processor may, for instance, consist in increasing the activation frequency of the security thread, or in increasing the activation frequency of the program to be made secure, or in the exclusive activation of said security thread.

Other particularities and advantages of the invention will clearly appear when reading the following description thereof, submitted as illustration and by no means as a limitation, and referring to the appended drawings, wherein:

FIG. 1 shows the execution of a secured code according to the invention.

FIG. 2 shows two executions of the same secure code according to the invention.

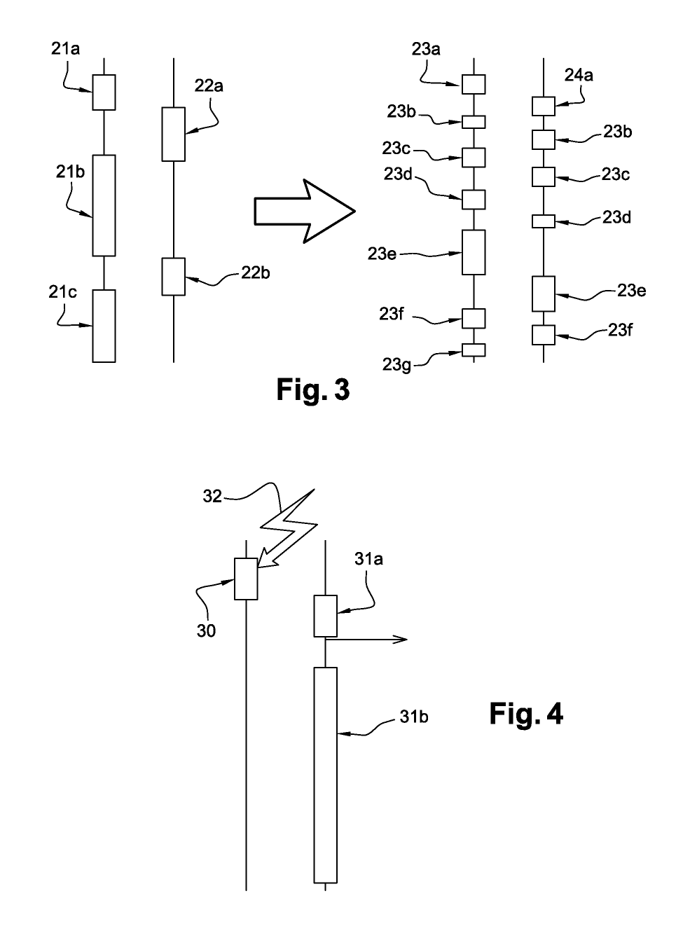

FIG. 3 shows the reaction of the secured system according to the invention after a suspected attack.

FIG. 4 shows the reaction of the secure system according to the invention in case an attack has been detected.

The securing method according to the invention may advantageously have two different implementations.

On the one hand, the process may be a self-contained and independent thread. This is, for instance, the case, when such thread is a program, loaded into the device to be made secure and executed as a program.

Another solution consists in integrating such thread into the system itself. Such integration can advantageously be made in the operating system, for instance in the scheduler. Such solution provides security which is enhanced by the security inherent to the content of the operating system.

In the particular case of securing the execution of a program which is executed through a virtual machine, it may be particularly advantageous to integrate such securing thread within the virtual machine.

In the following part of the present description, the word Thread will be used for referring equally to such various embodiments.

FIG. 1 shows two threads executed by the same processor in an electronic device, for instance, a portable telephone. The first thread 1a, 1b is a program to be made secure (for instance, an electronic signature program), which is executed within a virtual machine. The second thread, called “security thread” is a functionality integrated in the operating system.

According to the invention, the scheduler of the operating system interrupts the execution of the main thread in order to allow the execution of the security thread. Such disruption may be regularly executed, but in a preferred embodiment, such sequencing takes place according to at least one parameter, called a random parameter. Such parameter makes it possible to trigger, according to a hazard or a pseudo-hazard, the activation of the security thread.

In a preferred embodiment, the invention may operate with two parameters: one frequency parameter and one random parameter. The frequency parameter makes it possible to define a minimum time between two activations. When the minimum time has elapsed, the random parameter is taken into account in order to prevent the prediction of the activation of the security thread.

In a particularly advantageous embodiment of the invention, the scheduler may wait for a signal from the security thread, prior to reactivating the main thread, thus, if the security thread has been disturbed, the main thread is not reactivated.

Once activated, the security thread will execute a set of controls, called “integrity commands” 3a, 3b, which make it possible to control the correct execution of the main thread. Such commands may be any control able to read, and estimate at least one value 4a, 4b from the main thread. In the case of a virtual machine, such integrity commands can advantageously check data from the virtual machine, linked with the execution of the main thread.

The virtual machines have a lot of information relating to the program(s) being executed. Such information may be classified in two large categories: information relating to the data, and information relating to the execution itself.

The control can thus be made on data, or on the execution.

In the case of a control of data, the security thread may control, for instance, the content of the “stack” or the content of the “heap”.

In the case of a control of the execution, the security thread may control, for instance, the execution stack or the program counter.

In order to make such controls possible, the security thread must have references values to control. Such values may be directly provided in the code of the main thread, or may be computed by the security thread, depending on the information relating to the main thread, contained in the virtual machine.

FIG. 2 illustrates two executions of the same program 11a, 11b, 11c, 13a, 13b, 13c, 13d, secured according to the present invention. In this exemplary embodiment, only the random parameter is used. Once the main thread has been activated, the scheduler draws a random value, which defines the next disruption of the main thread to activate the security thread.

In the execution 11a, 11b, 11c, the scheduler has activated the security thread twice: 12a and 12b.

In the second execution, 13a, 13b, 13c, 13d, the scheduler executed 3 disruptions.

Such figure also shows the difference in duration of the security thread executions. Such mechanism according to the invention is based on a random number ideally different from the random parameter, as mentioned above, which makes it possible to define the integrity commands executed by the security thread during one of the activation thereof. In this implementation, upon each activating, the security thread executes more or less integrity commands, depending on such value. This value may be drawn by the thread itself, or may be provided by the scheduler upon activating the security thread.

In an advantageous mode, the invention provides for the security thread to store information relating to the executed integrity commands. This avoids carrying out the same commands upon each activating, and thus to favour a maximum completeness of the executed commands.

FIG. 3 illustrates the reaction of the scheduler, further to a suspected attack.

In FIG. 3, the main thread 21a, 21b, 21c, is secured by the security thread 22c, 22b, according to the invention. Upon one of the integrity commands executed by the security thread, a so-called “hazardous” situation has been detected. Such a criterion is defined in the integrity commands. Most often, the results of the integrity commands are analyzed by the security thread, in the light of the security rules. The result of such analysis is thus capable of defining the current situation as being, for example:
“secure” or “normal”: no anomaly detected
“hazardous”, or suspicion: at least one result is abnormal, but no critical data item is threatened
attack detected: the integrity, confidentiality or availability of the controlled application are jeopardized.

In the case illustrated in FIG. 3, the situation is “hazardous”. According to the invention, the security thread, after such an analysis, sent the scheduler a message to announce the situation. According to the invention, the scheduler has thus changed its parameters to accentuate the security controls, and thus increased the activation of the security thread. In the continuation of the main thread execution 23a, 23b, 23c, 23d, 23e, 23f, 23g, the scheduler has increased the activation frequency of the security thread 24a, 24b, 24c, 24d, 24e, 24f. This makes it possible to detect any evolution of the situation with as much reactivity as possible.

The result of the analysis carried out by the integrity commands in the “hazardous” situation shown in FIG. 3, may, depending on the security rules, make the situation change over time.

According to the results of the analysis, if no additional risk has been detected, when a given time as defined in the security rules has elapsed, the security thread may send the scheduler an item of information aiming at resetting the process sequencing back to a so-called “normal” situation, for instance close to the one shown in FIG. 2. On the contrary, if new “abnormal” information items are detected, the security thread may send the scheduler an item of information causing a reinforcement of the security constraints, for instance by enhancing the activation frequency of the security thread.

FIG. 4 illustrates a case, according to the invention, where a fault has been detected.

Such situation may occur when the security thread detects an attempted attack carried out on the main thread, or, if the suspicions for instance having led to the situation shown in FIG. 3, are too strong or too recurrent.

In this reaction of the system, an attack is carried out by a malicious user, or a malicious program, against the main thread 30. Such attack is detected by the security thread 31a. Such detection may for instance be made by analyzing the execution stacks or the heap of the virtual machine, which executes the thread 30. The security thread sends emergency information 32 to the scheduler. Upon receiving this particular message, the scheduler knows that it must no longer activate the main thread. Such measure mainly aims at protecting the main thread. As a matter of fact, the hacker will not be able to reap the benefits of his/her attack, as long as it has not been reactivated. The security thread will advantageously switch to the mode 31b, wherein it will be able to react against the detected attack.

Such reaction can occur in various, non exclusive ways, the combination of which is even recommended according to the invention:
deletion of the content of the memories linked to the main thread, and more particularly the registers, stacks, execution stacks, heaps . . . of the virtual machine, if need be.
Writing of data instead of the information relating to the main thread, and more particularly registers, stacks, execution stacks, heaps . . . of the virtual machine, if need be.
Transmission of an information item outside of the device, depending on the available means.
Writing at least one item of information on said attack into a non volatile memory of the electronic device, and preferably, writing all the satellite information (identifier of the devices, if any, connected upon the attack, report from all the security sensors, if any, upon the attack, . . . )
Writing a device locking data item into a non volatile system memory, in order to prevent a “normal” starting-up of the device.
. . .

In a preferred embodiment of the invention, the item of information sent by the security thread to the scheduler if an attack is detected can be sent by any means known to the person skilled in the art, more particularly through disruptions, and this aims at accelerating such a transmission, and at making a possible interception as difficult as possible.

1. A method for securing the execution, in an electronic device including at least one processor and one memory, of a computer program in a multitask environment comprising a program called a scheduler, for managing the load of said processor, comprising:
the execution of a security thread, in parallel with the execution of said computer program,
the execution by said thread, of at least a controlling operation on the execution of said computer program,
the analysis of the results of said controlling operation; and
the sending at least one item of information to said scheduler.

2. A method according to claim 1, wherein said computer program is executed within a virtual machine.

3. A method according to claim 1, wherein said controlling operation comprises analyzing at least one sensor.

4. A method according to claim 3, wherein said sensor is a software sensor.

5. A device according to claim 3, wherein said sensor is a hardware sensor.

6. A method according to claim 1, wherein said controlling operation comprises analysing, in said memory, values produced by said computer program.

7. A method according to claim 2, wherein said controlling operation comprises in analyzing a stack of the virtual machine.

8. A method according to claim 2, wherein said controlling operation comprises in analyzing a heap of the virtual machine.

9. A method according to claim 2, wherein said controlling operation comprises in analyzing an execution stack of the virtual machine.

10. A method according to claim 2, wherein said controlling operation comprises in analyzing an execution counter of the virtual machine.

11. A method according to claim 1, wherein said information item comprises of an activation frequency of said security thread.

12. A computer-readable medium encoded with a program for managing the load of a processor in a multitask environment, which causes the processor to perform the following operations:
execute a security thread in parallel with the execution of a program to be made secure;
receive an item of information from said thread; and,
depending on said received information item, modify the activation frequency of each process being executed by said processor.

13. A computer-readable medium program according to claim 12, wherein said modification in the activation frequency of each process being executed by said processor comprises increasing the activation frequency of said security thread.

14. A computer-readable medium program according to claim 12, wherein said modification in the activation frequency of each process being executed by said processor comprises increasing the activation frequency of said program to be made secure.

15. A computer-readable medium program according to claim 12, wherein said modification in the activation frequency of each process being executed by said processor comprises exclusive activation of said security thread.
